(19) United States
(12) Patent Application Publication
(10) Pub. No.: US 2025/0368048 A1
(43) Pub. Date: Dec. 4, 2025

(54) ACTIVE DISCHARGE SYSTEM FOR ELECTRIC VEHICLE

(71) Applicant: FCA US LLC, Auburn Hills, MI (US)

(72) Inventors: Rudolf B. Kharpuri, Auburn Hills, MI (US); Omkar Anand Bedarkar, Windsor (CA)

(21) Appl. No.: 18/679,815

(22) Filed: May 31, 2024

(51) Int. Cl. B60L 3/04; B60L 3/00; B60L 58/20; H02H 7/18

(52) U.S. Cl. CPC B60L 3/04; B60L 3/0007; B60L 58/20; H02H 7/18

(57) ABSTRACT

An electric vehicle includes an electric traction motor, a high voltage (HV) battery system including a HV bus and a HV battery configured to power the electric traction motor, an active discharge circuit configured to remove residual voltage on the HV bus, a low voltage battery system including a low voltage battery, a motor control processor (MCP) configured to control the electric traction motor, and a powertrain control system for managing an active discharge of the HV bus during a fault event. A controller is programmed to detect a HV shutdown event due to the fault event, disconnect the HV battery from the HV bus, send an active discharge command to the MCP to remove residual voltage by the active discharge circuit. determine the controller and/or the MCP have momentarily lost power after the fault event, and resend the active discharge command to the MCP.

### FIELD

The present application relates generally to electric vehicle control systems and, more particularly, to electric vehicle control systems to remove residual voltage from the high voltage system.

### BACKGROUND

An electric vehicle (EV) powertrain typically includes one or more electric motors. The electrified portion of the electric powertrain vehicle often includes a high voltage (HV) battery system and a low voltage (e.g., 12 volt) battery system. In such a configuration, the HV battery system is utilized to power the electric motor and power/recharge the low voltage battery system via a direct current to direct current (DC/DC) converter. During certain HV faults such as impact events, it is imperative to quickly remove and dissipate power on the HV DC bus. Accordingly, while such conventional systems do work well for their intended purpose, there is a desire for improvement in the relevant art.

### SUMMARY

In accordance with one example aspect of the invention, an electric vehicle is provided. In one example implementation, the electric vehicle includes an electric traction motor, a high voltage (HV) battery system including a HV bus and a HV battery configured to power the electric traction motor, an active discharge circuit configured to remove residual voltage on the HV bus, a low voltage battery system including a low voltage battery, a motor control processor (MCP) configured to control the electric traction motor, and a powertrain control system for managing an active discharge of the HV bus during a fault event. A controller is programmed to detect a HV shutdown event due to the fault event, disconnect the HV battery from the HV bus, send an active discharge command to the MCP to remove residual voltage by the active discharge circuit. determine the controller and/or the MCP have momentarily lost power after the fault event, and resend the active discharge command to the MCP.

In addition to the foregoing, the described electric vehicle may include one or more of the following features: wherein the fault event is a vehicle impact event; wherein the active discharge circuit is configured to remove residual energy stored in one or more capacitors; wherein the controller disconnects the HV battery from the HV bus via one or more contactors; and wherein the powertrain control system further includes an Active Discharge Occurred Determination subsystem configured to determine if the MCP received the active discharge command after the fault event and is actively discharging the residual voltage, wherein the controller is further programmed to (i) complete the active discharge if it is determined the MCP received the active discharge command and is actively discharging the residual voltage, and (ii) subsequently disable the active discharge command to the MCP.

In addition to the foregoing, the described electric vehicle may include one or more of the following features: wherein the powertrain control system further includes a HV Parameter Monitoring subsystem configured to monitor if the voltage on the HV bus is greater than a predetermined threshold, wherein the controller is configured to resend the active discharge command to the MCP if the HV Parameter Monitoring subsystem indicates the monitored voltage is greater than the predetermined threshold; wherein the supervisory controller and the MCP are powered by the low voltage battery system; wherein the momentary loss of power to the controller and/or the MCP causes a loss of signal communication between the controller and the MCP; and wherein the momentary loss of power to the controller and/or the MCP causes the controller and/or the MCP to reset.

In accordance with another example aspect of the invention, a method of operating a powertrain control system to manage an active discharge of an electric vehicle is provided. The electric vehicle includes an electric traction motor, a high voltage (HV) battery system including a HV bus and a HV battery, an active discharge circuit configured to remove residual voltage on the HV bus, and a motor control processor (MCP) configured to control the electric traction motor.

In one example implementation, the method includes (i) detecting, by a controller having one or more processors, a HV shutdown event due to a fault event; (ii) disconnecting, by the controller, the HV battery from the HV bus; (iii) sending, by the controller, an active discharge command to the MCP to remove residual voltage by the active discharge circuit; (iv) determining the controller and/or the MCP have momentarily lost power after the fault event; and (v) resending, by the controller, the active discharge command to the MCP.

In addition to the foregoing, the described method may include one or more of the following features: wherein the fault event is a vehicle impact event; wherein the active discharge circuit is configured to remove residual energy stored in one or more capacitors; wherein the controller disconnects the HV battery from the HV bus via one or more contactors; and wherein the electric vehicle includes a powertrain control system having an Active Discharge Occurred Determination subsystem, the method further including (i) determining, by the Active Discharge Occurred Determination subsystem, if the MCP received the active discharge command after the fault event and is actively discharging the residual voltage, (ii) completing the active discharge if it is determined the MCP received the active discharge command and is actively discharging the residual voltage, and (iii) subsequently disabling, by the controller, the active discharge command to the MCP.

In addition to the foregoing, the described method may include one or more of the following features: wherein the powertrain control system further includes a HV Parameter Monitoring subsystem, the method further including (i) monitoring, by the HV Parameter Monitoring subsystem, if the voltage on the HV bus is greater than a predetermined threshold, and (ii) resending, by the controller, the active discharge command to the MCP if the HV Parameter Monitoring subsystem indicates the monitored voltage is greater than the predetermined threshold; wherein the supervisory controller and the MCP are powered by the low voltage battery system; wherein the momentary loss of power to the controller and/or the MCP causes a loss of signal communication between the controller and the MCP; and wherein the momentary loss of power to the controller and/or the MCP causes the controller and/or the MCP to reset.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle architecture in accordance with the principles of the present application;

FIG. 2 is a graph of an example DC bus active discharge profile of the electric vehicle shown in FIG. 1, in accordance with the principles of the present application;

FIG. 3 is a graph illustrating an example system operation during a power loss of the electric vehicle shown in FIG. 1, in accordance with the principles of the present application;

FIG. 4 is a graph illustrating another example system operation during a power loss of the electric vehicle shown in FIG. 1, in accordance with the principles of the present application; and

FIG. 5 illustrates an example control logic flow for operating an electrified powertrain system of the electric vehicle shown in FIG. 1, in accordance with the principles of the present application.

### DETAILED DESCRIPTION

As discussed above, an electric vehicle (EV) or hybrid electric vehicle (HEV) powertrain includes a high voltage (HV) battery system and a low voltage battery system. Under normal operations, a supervisory controller commands an ‘Active Discharge’ to remove residual voltage from the HV system. Under certain failure modes, such as a vehicle impact event, a momentary low voltage loss may cause a loss of communication, which may result in the active discharge command not being received. Accordingly, described herein are systems and methods for managing and resending the active discharge command to the electric drive modules (EDMs) for certain exceptional cases by monitoring HV system parameters.

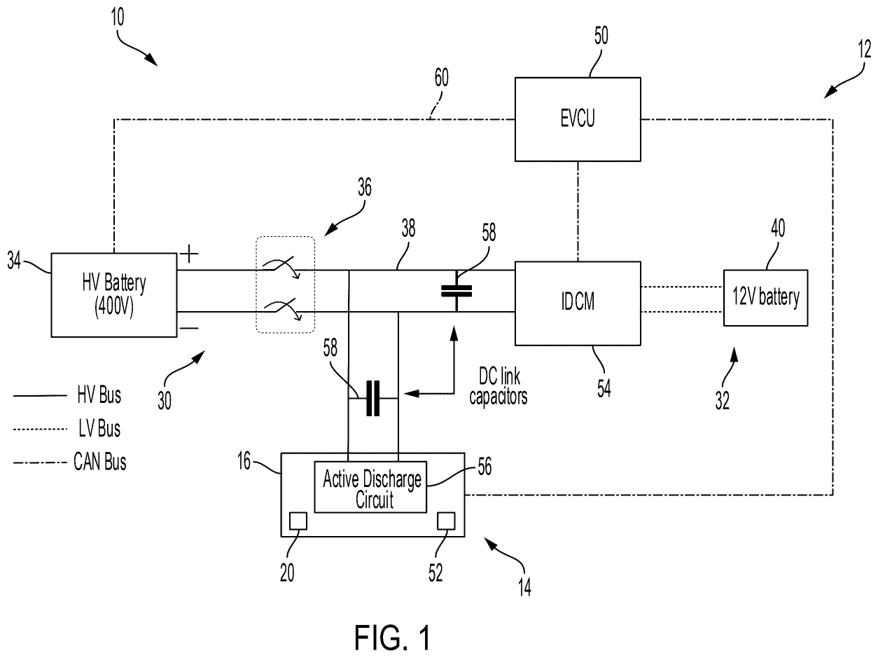

With initial reference to FIG. 1, a schematic diagram of an electric vehicle (EV) 10 is illustrated having an electrified powertrain 12 and a powertrain control system 14 according to example implementations of the disclosure. In the illustrated example, the powertrain 12 generally includes one or more electric drive modules (EDMs) 16, which include an electric traction motor 20 electrically coupled to a power inverter module (PIM) (not shown) configured to selectively provide drive torque to a front axle and/or a rear axle (not shown). In some configurations, the vehicle 10 is a hybrid electric vehicle (HEV) and the powertrain 12 also includes an internal combustion engine and a motor/generator (not shown), as is known in the art.

To provide electric power and control to the electric traction motor 20, the vehicle 10 includes a high voltage (HV) battery system 30 and a low voltage (e.g., 12V) battery system 32. The HV battery system 30 includes a HV traction battery 34 (e.g., 48V) to power high voltage loads such as the EDM 16. Contactors 36 are included as an electromechanical switching device utilized to selectively connect the HV battery 34 to a HV DC bus 38 of the high voltage battery system 30. In some examples, the contactors 36 are integrated with the HV battery 34. The low voltage battery system 32 includes a low voltage (e.g., 12V) battery 40 configured to support various low voltage loads of the vehicle 10, for example, to power various electrical components.

In the example embodiment, the electrified powertrain 12 is controlled by the powertrain control system 14, which generally includes an electric vehicle control unit (EVCU) or controller 50, a motor control processor (MCP) 52, an integrated dual charge module (IDCM) 54, and an active discharge circuit 56 configured to remove residual energy stored on one or more direct current (DC) link capacitors 58. The MCP 52, IDCM 54, and active discharge circuit 56 are HV components connected to the HV battery 34 via the switches/contactors 36 and HV bus 38.

The controller 50 is a central supervisory control configured to communicate with various components/modules of the electric powertrain 12 via a CAN bus 60. The electric motor 20 is directly controlled by the MCP 52, which is a controller configured for bi-directional communication with the controller 50 via the CAN bus 60. The controller 50 is configured to control the electric motor 20 by forwarding signals, such as operation state, torque command, and voltage setpoints to the MCP 52, and the MCP 52 provides feedback signals to the controller 50 related to the electric motor 20 such as operation status, output current, and voltage. The IDCM 54 is a combination of an onboard charger, and an auxiliary power module (APM) or a DC/DC converter (not shown). In one example, the IDCM 54 is a HV module configured to charge the HV battery 34 (via the onboard charger) and the 12V battery 40 (via the APM).

In the example embodiment, the supervisory controller 50 is responsible for controlling the HV components, for example, by closing the contactors 36 to provide high voltage on the DC bus 38 during a power-up sequence to allow the vehicle 10 to drive or charge. This allows the rest of the HV components to access the HV battery 34 to perform functions like driving or charging. On a power-down sequence, such as at the end of a driving/charging cycle or due to a fault, the supervisory controller 50 is configured to disconnect (or put in an open state) the HV battery 34 from the rest of the vehicle 10, as well as remove the residual energy stored in the capacitors 58 via the active discharge circuitry 56 by sending an active discharge command to the MCP 52.

As described herein in more detail, the powertrain control system 14 is configured to retry removal of the of the residual voltage (or energy) present in the HV bus 38 by re-sending the active discharge command to the EDMs 16 for exceptional cases such as, for example, an impact event. The supervisory controller 50 include application software to perform such operations.

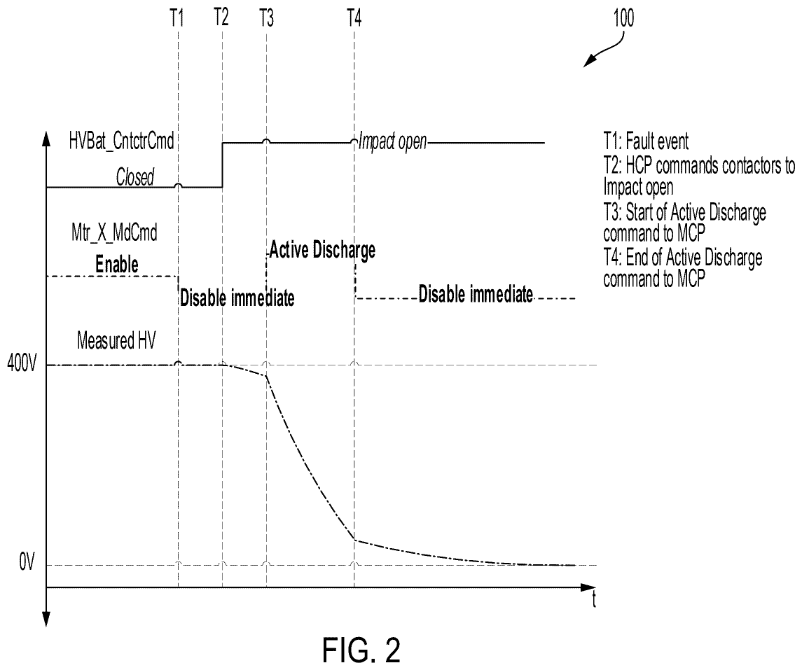

With additional reference now to FIG. 2, one example operation of the powertrain control system 14 during a fault event, such as a vehicle impact event, is shown by graph 100, which illustrates system voltage (V) over time (t). The supervisory controller 50 in the electric or hybrid vehicle 10 commands operation of the EDM 16 via CAN messages. Example commands include: ‘Enable Inverters’ to allow operation during driving (e.g., during a power-up sequence); ‘Disable Inverters’ to discontinue operation at the end of a driving cycle or during regular power-off scenarios (e.g., during a power-down sequence); ‘Command Active Discharge’ to perform active discharge of the DC bus 38 (e.g., during a vehicle impact event); and ‘Immediate Disable of Inverters’ to disable inverters in case of certain vehicle faults.

In normal operation during a shutdown sequence, the supervisory controller 50 controls the other HV components (e.g., HV battery, MCP, IDCM, etc.) to achieve the HV shutdown within a predetermined time. It does this by recognizing the event, disabling all the HV components such that they stop consuming HV, disconnecting the HV battery 34, and finally removing the residual voltage on the HV bus 38 via the active discharge circuit 56.

During a fault scenario, such as a vehicle impact event, the same operation as the normal shutdown sequence is performed, but with an expedited timeline. For example, in one embodiment, during certain vehicle HV faults, the power is removed and dissipated on the HV bus 38 to below a predetermined threshold (e.g., 60V) within a predetermined time (e.g., 5.0 seconds). The various electrified powertrain (ePT) modules (e.g., EVCU, BPCM, MCP, IDCM) on hybrid or electric vehicles have different strategies to meet this objective.

As shown in FIG. 2, a fault event occurs at time (T1). The controller 50 then commands the HV contactors 36 to open at time (T2). To remove the residual voltage once the HV battery 34 is disconnected via contactors 36, the supervisory controller 50 commands ‘Active Discharge’ to the motor control system at time (T3). This allows the motor control system to actuate active discharge circuitry 56 to dissipate power on the HV bus 38 once the contactors 36 are open. In the example embodiment, the active discharge circuitry 56 includes a resistor controlled by a switch/transistor (not shown). The controller 50 monitors the DC bus voltage reading sent via CAN from the MCP 52 (or other HV component) and stops commanding active discharge once the voltage is below the predetermined threshold at time (T4). The active discharge command may also be stopped upon additional conditions for system protections such as, for example, maximum timeout, HV voltage not present, welded contactors, etc.

In the example embodiment, the strategy to remove HV from the DC bus 38 includes a redundant path. For example, one path via controller 50 and MCP 52 (primary path) and a second path via the IDCM 54. The secondary path may be done autonomously, but under similar conditions and after the HV contactors 36 are opened.

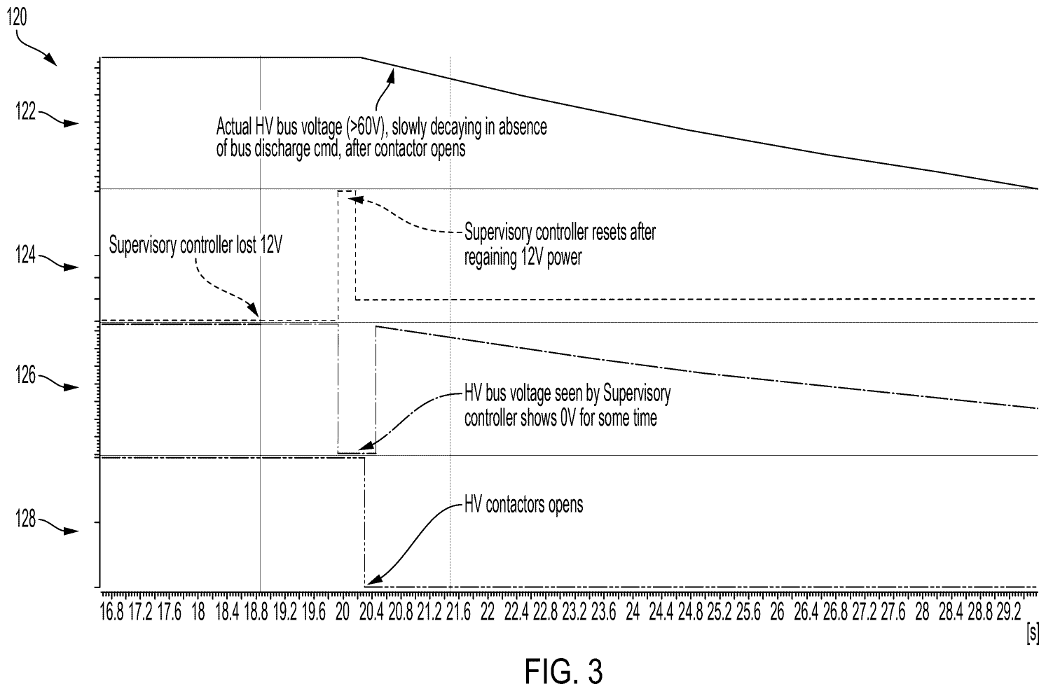

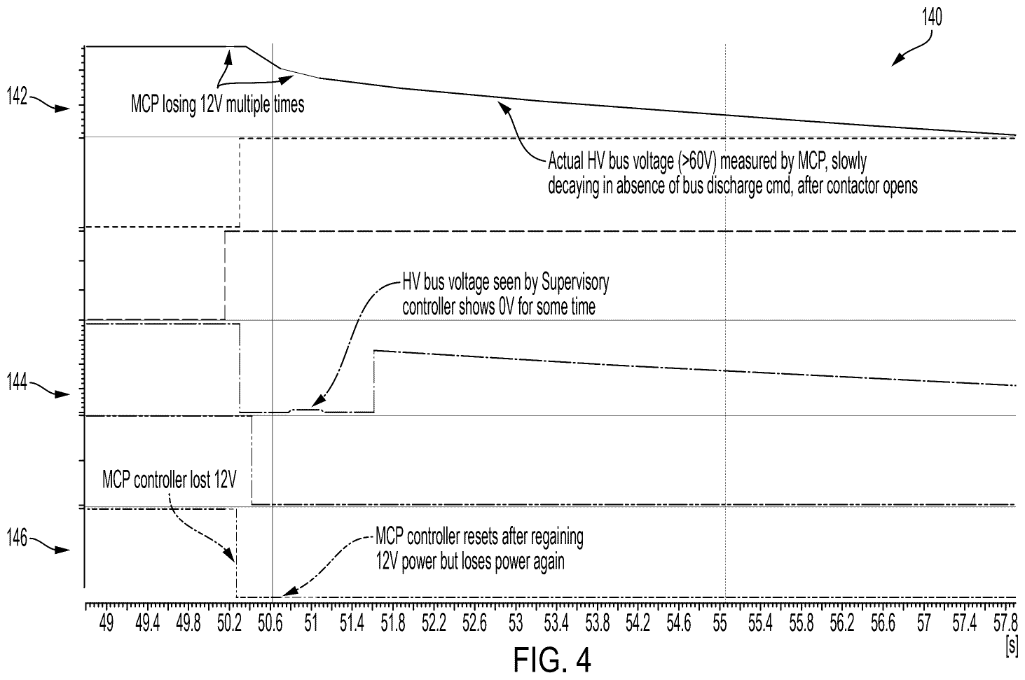

With additional reference to FIGS. 3 and 4, under certain failure modes where the IDCM 54 is disconnected from the vehicle (or disabled) and only the primary path is operational, the low voltage battery system 32 may suffer a momentary loss of power (e.g., due to an impact event). This in turn may cause a momentary loss of communication between the supervisory controller 50 and the MCP 52, which are powered by the low voltage battery system 32. As such, the MCP 52 may potentially miss the active discharge command from the supervisory controller 50, or the supervisory controller 50 (after regaining power) may not be able to read the actual HV reading from the MCP 52 or IDCM 54.

FIG. 3 illustrates an example graph 120 of system interaction during a low voltage loss to controller 50 with actual HV bus voltage 122, supervisory controller power 124, HV bus voltage seen by the supervisory controller 126, and HV contactor status 128. FIG. 4 illustrates an example graph 140 of system interaction during a low voltage loss to MCP 52 with actual HV bus voltage 142, HV bus voltage seen by the supervisory controller 144, and MCP power 146.

Further, these low voltage disturbances may manifest in the form of controller resets where the controller 50 or MCP 52 resets in a short period of time (milliseconds), but introduces delays in the system. Such resets may cause the controllers to re-initialize the system, which then impacts voltage sensor and other sensor readings until they stabilize. Additionally, since an impact event demands a faster shutdown of the HV system, the supervisory controller 50 includes shorter timers in such a scenario.

As such, this combination of failures and system reaction may potentially result in not commanding or not completing the active discharge operation within the predetermined time. While other ePT modules such as the IDCM 54 can also perform active discharge of the HV bus 38 in case of vehicle impact, it is desirable for the supervisory controller's DC bus power dissipation operation to be resilient enough to address such momentary loss of communication scenarios. Further, during the active discharge period, the supervisory controller 50 does not continuously issue the active discharge command as this could lead to MCP component failure during other failure modes such as contactor welded scenarios. Accordingly, the controller 50 only sends the active discharge command when needed.

In this way, the supervisory controller 50 is configured to intelligently retry sending the active discharge command to the MCP 52 once communication between the modules is restored and the controller 50 observes that the DC bus voltage remains above the predetermined threshold (e.g., 60V). Moreover, this scenario may also occur in case of a double failure where the IDCM 54 is incapable of performing active discharge and there is a momentary loss of communication between the supervisory controller 50 and the MCP 52.

In the example embodiment, the supervisory controller includes additional control logic with a first, second, and third subsystem. The first subsystem, also referred to as Active Discharge Occurred Determination Subsystem, is configured to monitor if the supervisory controller 50 commanded active discharge to the MCP 52 within a given drive cycle. Typically, the MCP 52 provides a feedback signal regarding its current operation, which is primarily driven by the command from the supervisory controller 50. Additionally, HV bus measurement like voltage is also used to verify the response from the MCP 52. This subsystem also takes into consideration that when the MCP 52 goes into reset in the middle of an active discharge session and returns to operation, it will reset the output since the signals from the MCP 52 may be default (incorrect) values. This allows the subsystem to reevaluate the conditions once the MCP 52 comes back online. Finally, if it is determined that discharge has occurred, the logic ensures that the system does not perform active discharge continuously.

The second subsystem, also referred to as the HV Parameter Monitoring Subsystem, is configured to monitor various HV parameters such as voltage (or current) to determine if the system can or should retry sending the Active Discharge Command to the MCP 52. The output is set to TRUE if there is still power on the HV bus 38 or if it is above a predetermined threshold.

In the example embodiment, the outputs of the first and second subsystems are sent to the third subsystem, also referred to as an HV Management Subsystem, which utilizes both inputs to determine if the system needs to retry sending the Active Discharge Command to the MCP 52.

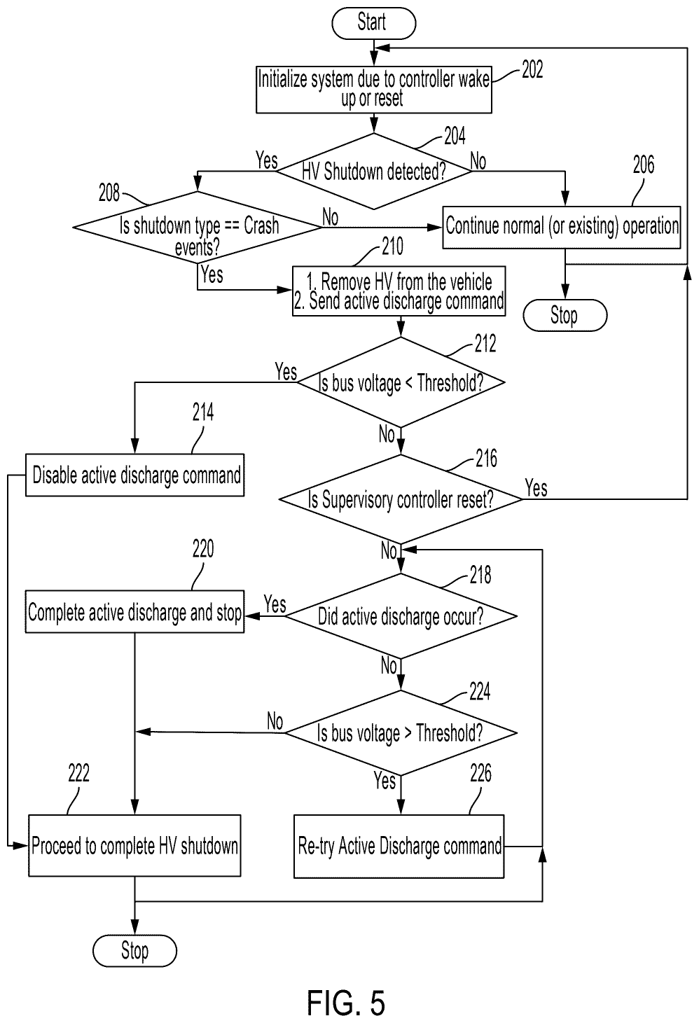

With reference now to FIG. 5, an example control logic flow 200 for operating the powertrain control system 14 to manage active discharge of vehicle 10 during a fault event, such as a vehicle impact event, is provided. The method begins at step 202, where the supervisory controller 50 (“control”) either wakes up or has gone through a reset where it will initialize (or reinitialize) the system starting with CAN communication with other modules on the network.

At step 204, the HV Management Subsystem determines if the vehicle 10 is in a shutdown state. If no, at step 206, control continues normal (or existing) operation and either stops or returns to step 202. If yes, control proceeds to determine if the type of shutdown is a vehicle impact event (e.g., crash event) and subsequently proceeds to remove the high voltage source (e.g., HV battery 34) and then the residual energy from the vehicle 10.

At step 208, the HV Management Subsystem determines if the HV shutdown is due to a vehicle impact event. If no, control proceeds to step 206 and continues normal/existing operation. If yes, at step 210, control removes HV from the vehicle 10 by opening contactors 36, and subsequently sends the active discharge command to the MCP 52.

After the impact event, it is possible that the supervisory controller 50 and/or the MCP 52 may momentarily lose low voltage power and go through a reset, which may affect subsequent steps. To account for such scenarios, control proceeds as follows.

At step 212, control determines if the HV bus voltage is less than a predetermined threshold (e.g., 60V), noting that it may be possible that the MCP 52 is going through a reset and signals like status or voltage reading may be unavailable. If yes, control proceeds to step 214 and disables the active discharge command and then proceeds to step 222. If no, control proceeds to step 216 and determines if the supervisory controller 50 has been reset.

At step 216, if the supervisory controller 50 has been reset, control returns to step 202 and reevaluates the system state once it has recovered. If the controller 50 is not reset, control proceeds to step 218 and determines if an active discharge has commenced. If yes, control proceeds to step 220 and completes the active discharge before proceeding to step 222. If the active discharge has not commenced, at step 224, control determines if the HV bus voltage is greater than a predetermined threshold (e.g., 60V). If no, control proceeds to step 222 and completes the HV shutdown. If yes, at step 226, control retries sending the Active Discharge Command to the MCP 52 and returns to step 218.

Accordingly, after an impact event, it is possible that the supervisory controller 50 and/or the MCP 52 may temporarily lose low voltage power and go through a reset, as previously described. If the supervisory controller 50 goes through a reset, as at 216, after some time the controller 50 will recover and reevaluate the system state. If the MCP 52 were to go through a reset, the feedback signals like active discharge status and voltage could be lost, as at step 212, and the subsystem would believe that active discharge is not needed. However, the Active Discharge Occurred Determination Subsystem is configured to rectify this situation once the MCP 52 comes back online, as at step 218, and account for stabilization time as well as to determine if the supervisory controller 50 ever sent the active discharge command to the MCP 52 in the current drive cycle. This enables the system to retry the active discharge command (step 226).

Further, if the supervisory controller 50 or MCP 52 missed the active discharge event (e.g., due to loss of power), the HV Management Subsystem may be held in a state believing that HV shutdown is complete. However, the HV Parameter Monitoring Subsystem is configured to reevaluate the voltage or power conditions of the HV bus 38 and, once the system stabilizes, the actual state of the system will be correctly determined, which triggers the active discharge retry to the MCP 52 until the residual voltage is removed.

Described herein are systems and methods for managing active discharge of a HV bus after a fault event, such as a vehicle impact event, where there is a momentary loss of communication between the supervisory controller and the motor control processor due to a loss of power. The solution is software based rather than hardware based, thereby reducing overall implementation costs associated with providing an active discharge command to the motor control processor to dissipate power across the HV bus. Further, the system is configured to retry sending the active discharge command to the motor control processor if predetermined conditions are met.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric vehicle, comprising:
an electric traction motor;
a high voltage (HV) battery system including a HV bus and a HV battery configured to power the electric traction motor;
an active discharge circuit configured to remove residual voltage on the HV bus;
a low voltage battery system including a low voltage battery;
a motor control processor (MCP) configured to control the electric traction motor; and
a powertrain control system for managing an active discharge of the HV bus during a fault event, including a controller having one or more processors programmed to:
detect a HV shutdown event due to the fault event;
disconnect the HV battery from the HV bus;
send an active discharge command to the MCP to remove residual voltage by the active discharge circuit;
determine the controller and/or the MCP have momentarily lost power after the fault event; and
resend the active discharge command to the MCP.

2. The electric vehicle of claim 1, wherein the fault event is a vehicle impact event.

3. The electric vehicle of claim 1, wherein the active discharge circuit is configured to remove residual energy stored in one or more capacitors.

4. The electric vehicle of claim 1, wherein the controller disconnects the HV battery from the HV bus via one or more contactors.

5. The electric vehicle of claim 1, wherein the powertrain control system further includes:
an Active Discharge Occurred Determination subsystem configured to determine if the MCP received the active discharge command after the fault event and is actively discharging the residual voltage,
wherein the controller is further programmed to (i) complete the active discharge if it is determined the MCP received the active discharge command and is actively discharging the residual voltage, and (ii) subsequently disable the active discharge command to the MCP.

6. The electric vehicle of claim 5, wherein the powertrain control system further includes:
a HV Parameter Monitoring subsystem configured to monitor if the voltage on the HV bus is greater than a predetermined threshold,
wherein the controller is configured to resend the active discharge command to the MCP if the HV Parameter Monitoring subsystem indicates the monitored voltage is greater than the predetermined threshold.

7. The electric vehicle of claim 1, wherein the supervisory controller and the MCP are powered by the low voltage battery system.

8. The electric vehicle of claim 7, wherein the momentary loss of power to the controller and/or the MCP causes a loss of signal communication between the controller and the MCP.

9. The electric vehicle of claim 8, wherein the momentary loss of power to the controller and/or the MCP causes the controller and/or the MCP to reset.

10. A method of operating a powertrain control system to manage an active discharge of an electric vehicle having an electric traction motor, a high voltage (HV) battery system including a HV bus and a HV battery, an active discharge circuit configured to remove residual voltage on the HV bus, and a motor control processor (MCP) configured to control the electric traction motor, the method comprising:
detecting, by a controller having one or more processors, a HV shutdown event due to a fault event;
disconnecting, by the controller, the HV battery from the HV bus;
sending, by the controller, an active discharge command to the MCP to remove residual voltage by the active discharge circuit;
determining the controller and/or the MCP have momentarily lost power after the fault event; and
resending, by the controller, the active discharge command to the MCP.

11. The method of claim 10, wherein the fault event is a vehicle impact event.

12. The method of claim 10, wherein the active discharge circuit is configured to remove residual energy stored in one or more capacitors.

13. The method of claim 10, wherein the controller disconnects the HV battery from the HV bus via one or more contactors.

14. The method of claim 10, wherein the electric vehicle includes a powertrain control system having an Active Discharge Occurred Determination subsystem, the method further comprising:
determining, by the Active Discharge Occurred Determination subsystem, if the MCP received the active discharge command after the fault event and is actively discharging the residual voltage;
completing the active discharge if it is determined the MCP received the active discharge command and is actively discharging the residual voltage; and
subsequently disabling, by the controller, the active discharge command to the MCP.

15. The method of claim 14, wherein the powertrain control system further includes a HV Parameter Monitoring subsystem, the method further comprising:
monitoring, by the HV Parameter Monitoring subsystem, if the voltage on the HV bus is greater than a predetermined threshold; and
resending, by the controller, the active discharge command to the MCP if the HV Parameter Monitoring subsystem indicates the monitored voltage is greater than the predetermined threshold.

16. The method of claim 10, wherein the supervisory controller and the MCP are powered by the low voltage battery system.

17. The method of claim 16, wherein the momentary loss of power to the controller and/or the MCP causes a loss of signal communication between the controller and the MCP.

18. The method of claim 17, wherein the momentary loss of power to the controller and/or the MCP causes the controller and/or the MCP to reset.
